(19) United States
(12) Patent Application Publication
(10) Pub. No.: US 2017/0168158 A1
(43) Pub. Date: Jun. 15, 2017

(54) ULTRASONIC NOISE BASED SONAR

(71) Applicant: Sound Solutions International Co., Ltd., Beijing (CN)

(72) Inventor: Friedrich Reining, Vienna (AT)

(21) Appl. No.: 15/284,255

(22) Filed: Oct. 3, 2016

Related U.S. Application Data
(60) Provisional application No. 62/236,744, filed on Oct. 2, 2015.

(51) Int. Cl. G01S 15/42; G01S 7/527; G01S 7/524; G01S 7/52

(52) U.S. Cl. CPC G01S 15/42; G01S 7/52004; G01S 7/5273; G01S 7/524

(57) ABSTRACT

The invention relates to a device with a microphone and a speaker or transducer and processing means to process audio signals from the microphone and for the transducer. Electronic devices and especially mobile devices serve several user interfaces of which the touch screen has revolutionized the market in the past few years. Ultrasonic gesture control has the power to add another interface that fills in for use cases where the touch screen is not reliable. This holds true for medical environments as well as for outdoor use cases just to name two. The invention suggests a different signal processing of the ultrasonic sending and receiving signals in order not to produce audible artefacts.

### BACKGROUND OF THE INVENTION

a. Field of the Invention

The invention relates to a device with a microphone and a speaker or transducer and processing means to process audio signals from the microphone and for the transducer. Electronic devices and mobile devices especially serve several user interfaces of which the touch screen has revolutionized the market in the past few years. Ultrasonic gesture control has the power to add another interface that fills in for use cases where the touch screen is not reliable. This holds true for medical environments as well as for outdoor use cases just to name two. The invention suggests a different signal processing of the ultrasonic sending and receiving signals in order not to produce audible artifacts.

b. Background Art

Ultrasonic sound is sound in frequencies above human audibility and starts about 16 kHz and covers the frequency range above. An ultrasonic transducer for gesture control can be any acoustic transducer capable of producing appropriate sound pressure level to calculate an object's position based on the reflected ultrasonic signals. State of the art ultrasonic transducers produce high sound pressure in or near their resonance frequency which is for example in the range of 30 kHz to 50 kHz.

As mobile devices already comprise a transducer and a microphone for audio frequencies, it is the aim to use this transducer to generate ultrasonic sound and to use this microphone to capture reflected ultrasonic sound for gesture control. State of the art solutions in sonar technologies use a chirp signal as ultrasonic signal as shown in FIG. 1. One of the drawbacks of using state of the art transducer optimized for the audio signal frequency area is the low efficiency when driven in the ultrasonic frequency area. A high driving voltage of the ultrasonic signal must be fed to the transducer to achieve an acceptable sound pressure. This might generate artifacts in the audible frequency range.

First of all the overall spectrum of the ultrasonic signal needs to be taken into account. FIG. 3 reveals a typical time signal with several high power ultrasonic sweeps (chirps) with a repetition rate of 100 Hz. The overall spectrum clearly contains, due to the repetition rate, energy in the audible range. While pure ultrasonic transducers would not detect that energy, transducers that are used for both the audible and the ultrasonic frequency range would.

Second, the high driving voltage can create highly stressed components which then exhibit nonlinear behavior. This in turn will produce nonlinear artifacts in the audible frequency area.

The problem of audible artefacts does not occur with ultrasonic transducers optimized for ultrasonic frequencies as they have their resonance frequency in the ultrasonic frequency area and only poor sound pressure in the human audible sound frequency area.

The problem arises to find a way to use the transducer of a mobile device optimized for audible sound frequencies as transducer for ultrasonic sound to enable gesture control without the drawback of audible artifacts.

### SUMMARY OF THE INVENTION

It is an objective of the invention to solve the problem of audible artifacts when using the transducer of a mobile device for gesture control. A new mobile device comprises improved processing means to use a noise signal as ultrasonic signal. Due to a low crest factor of the noise signal, processing of the noise signal does not generate distortion and nonlinear artefacts in the audible frequency area. The inventive processing means furthermore continuously adapt the filter length to calculate the correlation between sent and received ultrasonic sound for better gesture control as explained below with the embodiments of the invention.

The foregoing and other aspects, features, details, utilities, and advantages of the present invention will be apparent from reading the following description and claims, and from reviewing the accompanying drawings.

### BRIEF DESCRIPTION OF THE DRAWINGS

Further embodiments of the invention are indicated in the figures and in the dependent claims. The invention will now be explained in detail by the drawings. In the drawings:

FIG. 1 shows a symbolic block diagram of a mobile device that enables gesture control.

FIG. 2 shows a state of the art chirp signal used within sonar technologies.

FIG. 3 shows a train of state of the art chirp signals of FIG. 2 used for gesture control.

FIGS. 4A and 5A show a time frame of different noise signals used as ultrasonic signals for gesture control.

FIGS. 4B and 5B show captured ultrasonic signals reflected from an object.

FIGS. 4C and 5C show the result of the correlation of the ultrasonic signal with the captured ultrasonic signal used for gesture control.

### DETAILED DESCRIPTION OF EMBODIMENTS

Various embodiments are described herein to various apparatuses. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

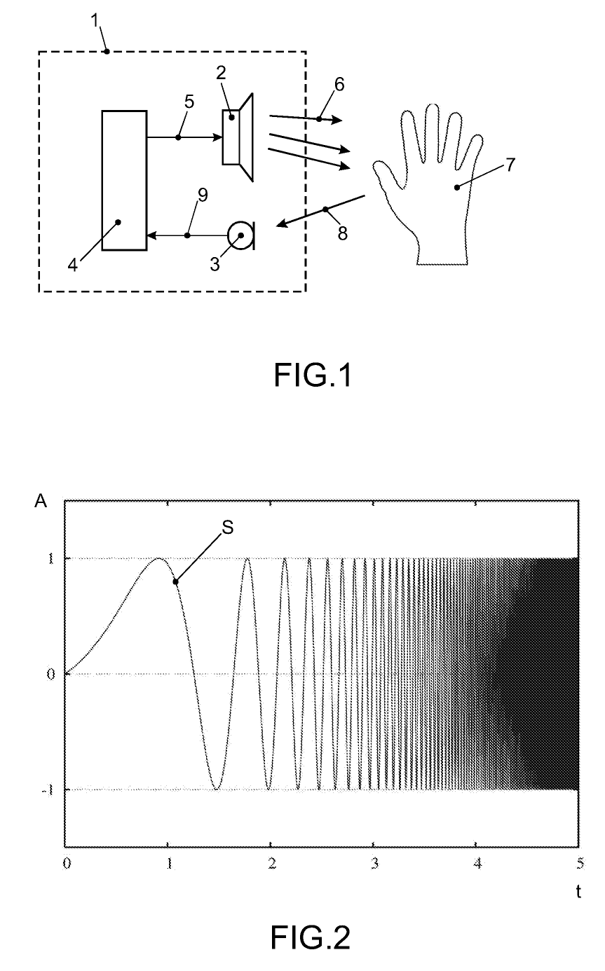

FIG. 1 shows a simple symbolic example of a mobile device 1 with a speaker or transducer 2 and a microphone 3 and processing means 4. Processing means 4 are built to process audio signals received from the microphone 3 and to process audio signals to be fed into the transducer 2 to e.g. enable a phone call with a mobile phone as mobile device 1. Processing means 4 furthermore are built to provide an ultrasonic signal 5 to the transducer 2 to generate ultrasonic sound 6 in frequencies above human audibility. Ultrasonic sound 6 is reflected on objects like a hand 7 and a reflected ultrasonic sound 8 is captured by microphone 3 which provides a captured ultrasonic signal 9 to processing means 4 for further processing. Processing means 4 may comprise components known in the art for processing audio and digital signals, including a digital to analog converter, an ultrasonic signal source, a low-pass filter, an audio signal processor, an ultrasonic signal processor, a digital signal processor (DSP) and/or an audio processor control.

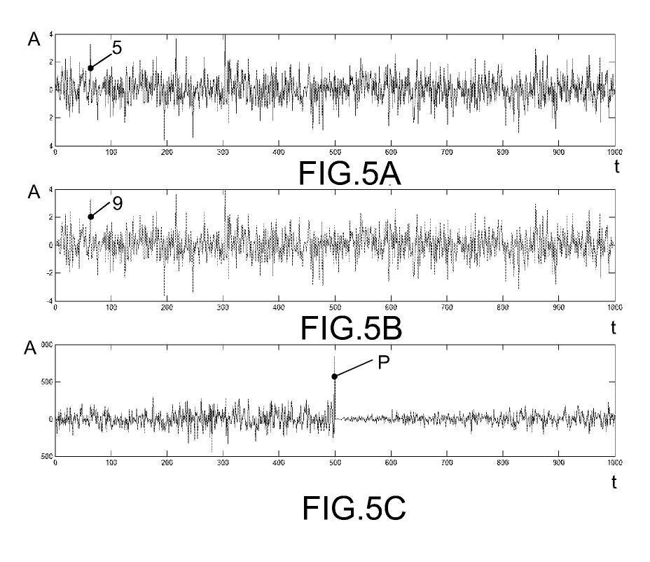

It is known technology to detect the distance and/or movement of an object by calculating the runtime difference between the ultrasonic signal 5 and the captured ultrasonic signal 9. This is realized by correlating these two signals and detecting a peak P within a resulting signal as can be seen in FIGS. 4C and 5C as explained below.

FIG. 2 shows a so called “chirp” used within sonar technologies to feed it as ultrasonic signal into an ultrasonic transducer. Chirp signal S with an amplitude A over time t starts with a rather low frequency, which increases over time or vice versa. One of the benefits of using a chirp instead of a pulse is the lower crest factor, which is the ratio between the maximum amplitude to the root means square amplitude being 1.414 for a sinusoid. The higher the crest factor of a signal the more harmonic waves and overtones are generated in a non-ideal channel like in transducer 2. On the other hand, a low crest factor means that most signal energy is found within the wanted region and therefore the system works efficiently.

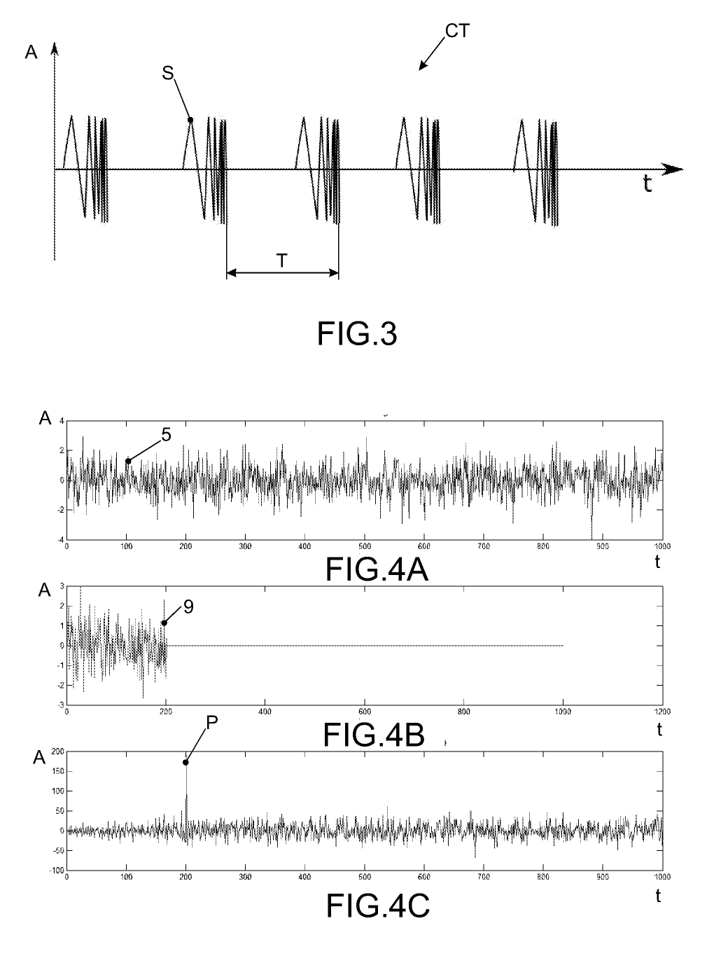

FIG. 3 shows a chirp train CT, with chirp signals S repeated after periods T. This is the typical way an ultrasonic signal 5 in a state of the art system is composed to detect the runtime of the ultrasonic signal 5 reflected from an object. For this chirp train CT of chirp signals S, the crest factor increases to about 4. If this chirp train CT would be used in mobile device 1 to detect the gesture of hand 7 the following significant drawbacks would occur:
The repetition rate 1/T is audible by a human and would be recognized by a user as annoying audible artefact.
When driving at the maximum power (averaged, thermal limit) any further SNR improvement needs to change the signal to a longer chirp hence reducing the output power due to the smaller gaps if the repetition rate should not be changed.
The power efficiency is not better than random noise normally distributed.

Inventive processing means 4 are built to generate or read-out from a memory ultrasonic signal 5 with a signal form of a noise signal as shown in FIGS. 4A and 5A and to feed this ultrasonic signal 5 into transducer 2. Such ultrasonic signal 5 is a vector of ultrasonic and hence bandlimited noise with a fixed signal shape in time domain and therefore known by processing means 4 with a specific length (˜1/framerate) which ultrasonic signal 5 can be repeated in a non-audible way (zero crossing).

FIGS. 4B and 5B show the captured ultrasonic signals 9 reflected from hand 7 that are used to correlate them with ultrasonic signals 5 shown in FIGS. 4A and 5A. The result of the correlation can be seen in FIGS. 4C and 5C and peak P marks the instance where the two signals 5 and 9 correlate. Processing means 4 are furthermore built to calculate the distance from hand 7 and movement of hand 7 based on these detected peaks P and to use this information to enable gesture control for mobile device 1.

As can be seen from FIGS. 4C and 5C, the SNR, the ratio between the calculated peak of reflection occurrence and the noise in the signal 5 and 9 is ˜20 dB given for rather bad signal to noise ratio in the captured ultrasonic signal 9. SNR=0 dB would mean that the signal is equally containing unwanted noise and the captured ultrasonic signal 9.

If unwanted noise would further increase due to a bad reflection scenario the system would end up with a SNR of −12 dB, which means, that processing means 4 get four times more unwanted noise than the wanted captured ultrasonic signal 9. To cope with such bad signal conditions the inventive processing means 4 update the filter length in order to pick more correlation features out of the captured ultrasonic signal 9 as can be seen from the example in FIG. 5. With this way to cope with a bad reflection scenario the resulting SNR of the occurrence detection is still +20 dB!

This is based on the principle that the filter length or length of the fixed noise signal used as ultrasonic signal 5 has to be increased if a weaker captured ultrasonic signal 9 is received covered with more noise what still enables good gesture detection results in bad reflection scenarios. On the other hand processor means 4 reduce the filter length or length of the fixed noise signal used as ultrasonic signal 5 if a stronger captured ultrasonic signal 9 is received covered with less noise what enables a more reactive and time wise accurate gesture control.

Using a fixed noise signal as ultrasonic signal yields three major advantages:
Inaudibility of the ultrasonic induced nonlinear artefacts.
Adaptive power management with adapted filter length based on signal to noise ratio.
Higher efficiency due to compression tendency of a speaker when driven to the limit (e.g. eddy currents).

In closing, it should be noted that the invention is not limited to the above mentioned embodiments and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention. The scope of the present invention is defined by the appended claims, including known equivalents and unforeseeable equivalents at the time of filing of this application.

What is claimed is:

1. An audio apparatus comprising:
an audio transducer capable of transmitting sound in the human audible range and in the ultrasonic range;
a microphone capable of detecting sound in the human audible range and in the ultrasonic range; and
a signal processor for processing signals to be transmitted to the audio transducer and for processing signals received from the microphone, the signal processor comprising:
an ultrasonic signal generator configured to generate an ultrasonic signal that is fed to the audio transducer; and
an ultrasonic signal processor configured to receive and process an ultrasonic signal detected by the microphone,
wherein the signal processor is configured to compare the ultrasonic signal fed to the audio transducer to the ultrasonic signal detected by the microphone and calculate the distance and movement of an object relative to the audio apparatus.

2. An audio apparatus according to claim 1, wherein the ultrasonic signal generator is configured to generate an ultrasonic signal that minimizes the audible artefacts due to the non-linearity of the sound reproduction by the said audio transducer.

3. An audio apparatus according to claim 1, wherein all frequencies contained in the ultrasonic signal generated by the ultrasonic signal generator are within an ultrasonic-frequency-range above 20 kHz.

4. An audio apparatus according to claim 1, wherein the ultrasonic signal generated by the ultrasonic signal generator has a repetition rate of less than 10 Hz and is inaudible.

5. An audio apparatus according to claim 1, wherein the signal processor is further configured to divide the ultrasonic signal generated by the ultrasonic signal generator into overlapping frames according to a requested frame rate and compare the overlapping frames to the ultrasonic signal detected by the microphone.

6. An audio apparatus according to claim 1, wherein the ultrasonic signal generated by the ultrasonic signal generator is a noise signal.

7. A method of detecting the relative location and movement of an object in relation to an audio apparatus utilizing ultrasonic sound, the audio apparatus comprising an audio transducer, a microphone and a signal processor, the method comprising the steps of:
generating, by the signal processor, an ultrasonic signal;
transmitting the generated ultrasonic signal from the signal processor to the audio transducer;
broadcasting, by the audio transducer, an ultrasonic sound based on the generated ultrasonic signal;
detecting, by the microphone, an ultrasonic signal reflected by an external object at a distance away from the audio apparatus;
calculating, by the signal processor, the location of the external object relative to the audio apparatus based on the generated ultrasonic signal and the reflected ultrasonic signal.

8. The method of claim 7, wherein the ultrasonic signal generated by the signal processor operates to minimize the audible artifacts due to the non-linearity of the sound reproduction by the audio transducer.

9. The method of claim 7, wherein the ultrasonic signal generated by the signal processor is comprised only of frequencies within an ultrasonic-frequency-range above 20 kHz.

10. The method of claim 7, wherein the ultrasonic signal generated by the ultrasonic signal generator has a repetition rate of less than 10 Hz and is inaudible.

11. The method of claim 7, wherein the calculating step further comprises:
dividing the ultrasonic signal generated by the signal processor into overlapping frames according to a pre-determined frame rate; and
comparing the overlapping frames to the ultrasonic signal detected by the microphone.

12. The method of claim 7, wherein the ultrasonic signal generated by the signal processor is a noise signal.
